(19) United States
(12) Patent Application Publication
(10) Pub. No.: US 2004/0040736 A1
(43) Pub. Date: Mar. 4, 2004

(54) Shielded cable

(75) Inventor: Shinichi Nishimura, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/646,887

(22) Filed: Aug. 25, 2003

(30) Foreign Application Priority Data
Aug. 27, 2002 (JP) 2002-246785
Jul. 3, 2003 (JP) 2003-191135

(51) Int. Cl. H01B 11/02

(52) U.S. Cl. 174/113 R

(57) ABSTRACT

In placement of a plurality of signal wires in a shielded cable, a plurality of signal wires for transmitting digital signals of a relatively high frequency are placed adjacent to an outer shield with which the shielded cable is covered, and also adjacent one to another. The degree of capacitive coupling maximized with respect to high-frequency signal wires is thereby maintained with stability, thus enabling impedance control. Also, a skew at the connection between the shielded cable and a connector can be reduced. Thus, a shielded cable is provided in which impedance control and skew control are easily and stably performed without using cost-increasing means such as addition of ground and power supply wires to improve signal quality.

### BACKGROUND OF THE INVENTION

1. Field of the Invention

The present invention relates to a shielded cable assembly and, more particularly, to a technique for improving electrical characteristics of signal wires in a shielded cable for connection between electronic appliances to improve the quality of signals transmitted through the cable and to effectively suppress radiant noise.

2. Related Background Art

With the speedup of signal processing in digital signal processors, there has been an increasing need to ensure both maintenance of signal quality and suppression of radiant noise. The need is particularly high in the case of an interface cable for signal transmission between digital appliances because the transmission distance is ordinarily long and because a stable ground to a chassis made of a conductive material cannot be provided in the vicinity of signal wires. For this reason, shielded cables have been used in which a plurality of signal wires in the cable are covered with a braid or the like. In shielded cables having a braided shielding or the like, the braided wire strongly couples with signal wires in cables and functions as a signal ground. Therefore, shielded cables are capable of improving the signal quality while suppressing radiant noise.

FIG. 9 is a cross-sectional view of a shielded cable having thirty-six signal wires held therein. Referring to FIG. 9, the shielded cable indicated by 101 has single wires A+, A−, B+, B−, C+, C−, D+, D−, E+, E−, F+, F−, G+, G−, H+, H−, I+, I−, J+, J−, K+, K−, L+, L−, M+, M−, N+, N−, O, P, Q, R, S, T, U, and V. Each single wire is covered with an insulating sheathe. Single wire O is a power supply line connected to a power supply via a connector (not shown). Seven single wires P, Q, R, S, T, U, and V are ground lines connected to ground through the connector (not shown). Each of pairs of single wires A+ and A−, B+ and B−, C+ and C−, D+ and D−, E+ and E−, F+ and F−, G+ and G−, H+ and H−, I+ and I−, J+ and J−, K+ and K−, L+ and L−, M+ and M−, and N+ and N− are twisted together to form fourteen twisted pairs A, B, C, D, E, F, G, H, I, J, K, L, M, and N. Seven pairs A, B, C, D, E, F, and G in the fourteen twisted pairs are for transceiving signals at a high rate of 10 MHz or higher. Seven pairs H, I, J, K, L, M, and N are for transceiving signals at a low rate of 10 MHz or lower. All the thirty-six signal wires are covered with an insulating film 2. An outer shield 3 in the form of a braid or the like is formed outside the insulating film 2. The outer surface of the outer shield 3 is covered with a jacket 4 made of an insulating material.

In Japanese Patent Application Laid-Open No. H11-213765 is described an arrangement in which single wires for transmitting signals of a relatively high frequency are placed separately from each other in a signal transmission cable for transmitting a plurality of signals of different frequencies. In this manner, crosstalk between signals of a relatively high frequency can be prevented.

In recent years, however, the frequencies of signals flowing through shielded cables have been further increased. In particular, the frequency of a clock signal and a plurality of digital data signals synchronized with the clock signal is 10 MHz or higher. The radiant noise problem has become more serious. Under such circumstances, there are two problems described below with respect to shielded cables based on the above-described conventional art.

The first problem relates to variations in impedance of twisted pairs in the case of transceiving signals at a high rate through a shielded cable. Variation in impedance is a cause of occurrence of radiant noise and failure to maintain the quality of a high-rate signal. Ideally, the characteristic impedance of a twisted pair in a single state is determined by the inductance of the single wires forming the twisted pair and the capacitive coupling between the two single wires in the space occupied by the twisted pair. The differential impedance in the case where a differential signal is transceived through the twisted pair is determined in the same way.

In actuality, around a twisted pair, conductors, i.e., single wires other than the twisted pair, exist and the capacitive coupling with the adjacent single wires considerably affects the impedance of the twisted pair. With respect to the twisted pair E shown in FIG. 9 as a line for transceiving a high-rate signal, the characteristic impedance of the twisted pair E is not determined by the inductance of the single wires E+ and E− alone. The single wires V and U, the twisted pair M for transceiving a low-rate signal and the twisted pairs D and F for high-rate signals exist around the twisted pair E, and the capacitive coupling with these wires considerably affects the characteristic impedance of the twisted pair E. Therefore, the capacitive coupling designed with respect to the twisted pair cannot be stably provided and the designed impedance value cannot be realized.

It is difficult in practice to fix the positional relationship between the twisted pair E for transceiving a high-rate signal and the single wires surrounding the twisted pair E by constantly maintaining through the entire length of the shielded cable 101 the positional relationship in structure as viewed in section. This is because the twisted pairs differ in their twisting pitch or the twisted pairs and the single wires differ in their thickness. The relationship between the twisted pair E for transceiving a high-rate signal and the surrounding wires, i.e., the twisted pair M for transceiving a low-rate signal, the twisted pairs D and F for transceiving high-rate signals, and the single wires V and U, changes largely with respect to the position in the lengthwise direction of the shielded cable 101. The value of capacitive coupling between the twisted pair E and the surrounding twisted pairs or single wires is thereby varied largely, resulting in variation in impedance value of the twisted pair E in the lengthwise direction of the shielded cable 101.

The number of surrounding twisted pairs, the number of surrounding single wires and the conditions of the surrounding twisted pairs and single wires vary with respect to the twisted pairs for high-rate signals, and there are differences between the relative characteristic impedance values of the twisted pairs for high-rate signals. In particular, the twisted pair G shown in FIG. 9 differs largely from the other twisted pairs A to F in the distance from the outer shield 3 of the shielded cable 101, the number of surrounding signal wires and the conditions of the surrounding signal wires. Therefore, the difference between the impedance value of the twisted pair G and those of the twisted pairs A to F is large. This is a cause of generation of radiant noise.

The second problem relates to a skew which is the difference between delay times of transmitting signals. In many cases, high-rate signals transceived through twisted pairs in a shielded cable are high-rate parallel data such as image data. In high-rate parallel transmission, it is necessary to minimize the skew with respect to each transmission path as far as possible. If a skew between signals is large, a timing margin is reduced and there is a possibility of failure to receive parallel data. In the case of the shielded cable 101 shown in FIG. 9, it is necessary to minimize the skew of the twisted pairs A, B, C, D, E, F, and G for high-rate signals. For minimization of the skew, equalization of the physical lengths of the twisted pairs A, B, C, D, E, F, and G and equalization of the conditions of the conductor and the dielectric surrounding the twisted pairs A, B, C, D, E, F, and G are required.

The single wires and twisted pairs mixedly provided in the shielded cable 101 are roughly divided into those placed in a central layer (twisted pairs A to F) and those placed in an outer layer (twisted pairs G to N and single wires O to V). In the process of manufacturing the shielded cable 101, it is necessary to twist wires so as not to form a portion in which the cable diameter is relatively increased. If the twisting pitch in the inner layer and the twisting pitch in the outer layer are equal to each other, the diameter of the cable assembly is increased. Ordinarily, therefore, the twisting pitch in the outer layer is reduced while the twisting pitch in the inner layer is increased. In the shielded cable 101, because of the difference between the twisting pitch of the twisted pairs placed in the inner layer and the twisting pitch of the twisted pairs placed in the outer layer, the signals wires in the inner layer and the signal wires in the outer layer differ largely in physical length from each other. Since in the twisted pairs A to G for high-rate signals, the twisted pairs A to F positioned in the inner layer and the twisted pair G positioned in the outer layer differ in physical length, the skew is so large that part of parallel data transceived through these signal wires can easily be lost.

The above-described skew problem also occurs at the connection between a shielded cable and a connector. The state of wire connection between an ordinary shielded cable and a connector is illustrated in (a) and (b) of FIG. 10. Section (a) of FIG. 10 is a cross-sectional view of a cable 201 incorporating single wires L1 to L7 and R1 to R7, and section (b) of FIG. 10 is a diagram schematically showing a state in which the single wires L1 to L7 and R1 to R7 are separated from each other and connected to a connector 210. When the cable is connected to the connector, ends of the bundled single wires are separated from each other and the separated single wires are connected one by one to contact pins of the connector. If intersection occurs between the single wires when the wires are connected, disconnection or the like may result. Ordinarily, therefore, the single wires in the cable 201 are parted into halves to be led to left and right portions of the connector 210. The parted single wires are connected in the order of L1 to L7 leftward from the contact pin nearest to a center of the connector 210 and in the order of R1 to R7 rightward. At the connection between the shielded cable and the connector, therefore, there is a large difference between the wiring length of the signal wires L1 and R1 allocated to the central position of the connector and the wiring length of the signal wires L7 and R7 allocated to end portions of the connector, so that a considerably large skew occurs.

In particular, as shown in Japanese Patent Application Laid-Open No. H11-213765, in a case where high-rate signal wires are placed separately from each other, the distance between some of the signal wires and connector pins of a connector assigned to the signal wires at the connection between the cable and the connector is necessarily large, the difference in wiring length is correspondingly large, and the skew is increased.

For the purpose of stabilizing the characteristic impedance of twisted pairs for transceiving high-rate signals and suppressing the skew, ground and power supply wires may be newly added in the shielded cable or each twisted pair may be covered with an conductive member. In such a case, however, the manufacturing cost of the shielded cable is increased and the handling of the cable becomes troublesome since the number of wiring is increased. Moreover, it cannot be ensured that variation in each twisted pair in the lengthwise direction and variation between twisted pairs are reduced with reliability.

### SUMMARY OF THE INVENTION

As means for maintaining improved signal quality and reducing radiant noise more effectively under circumstances where the rate of transmission of signals through a shielded cable is further increased, not only use of a shielded cable simply arranged to be covered with a braid but also devising the placement of a plurality of single wires and twisted pairs provided inside the braided shield are required. Therefore, an object of the present invention is to provide a shielded cable capable of easily and stably performing impedance control and skew control of twisted pairs for transceiving high-rate parallel signals without using cost-increasing means such as addition of ground and power supply wires.

According to the present invention, there is provided a shielded cable having first signal wires for transmitting digital signals of a relatively high frequency, second signal wires for transmitting digital signals of a relatively low frequency, and a conductor with which the first and second signal wires bundled in a state of being electrically insulated from each other are collectively covered, wherein the first signal wires are placed adjacent to the conductor and adjacent one to another.

In this invention, it is not necessarily required that all the plurality of signal wires for transmitting digital signals of a relatively high frequency be placed in an outermost layer in the shielded cable. In some case, the majority of the signal wires may be placed in the outermost layer to achieve the above-described object. Also, it is not necessarily required that all the plurality of signal wires for transmitting digital signals of a relatively high frequency be placed so as to be adjacent one to another. In some case, the majority of the signal wires may be placed in this manner to achieve the above-described object.

According to the present invention, there is also provided a shielded cable in which the first signal wires are twisted pairs.

According to the present invention, there is also provided a shielded cable in which a clock signal of 10 MHz or higher and a plurality of data signals synchronized with the clock signals are transmitted through the first signal wires.

According to the present invention, there is further provided a shielded cable in which the above-described shielded cable has connectors for connection at its opposite ends, each of the connectors having connector pins being connected to the first and second signal wires, the first signal wires being connected to particular ones of the connector pins which are adjacent one to another.

The above and other objects of the invention will become more apparent from the following description taken in conjunction with the accompanying drawings.

### BRIEF DESCRIPTION OF THE DRAWINGS

FIG. 1 is a cross-sectional view of a shielded cable in a first embodiment of the present invention;

FIG. 2 comprising sections (a) and (b) is a diagram schematically showing the state of connection between the shielded cable and a connector in the first embodiment of the present invention;

FIG. 3 is a diagram schematically showing an apparatus for measuring the impedance of the shielded cable;

FIG. 4 is a graph showing the results of measurement of the impedance of the shielded cable in the first embodiment;

FIG. 5 is a graph showing the results of measurement of the impedance of a conventional shielded cable;

FIG. 6 is a cross-sectional view of a shielded cable in a second embodiment of the present invention;

FIG. 7 comprising sections (a) and (b) is a diagram schematically showing the state of connection between the shielded cable and a connector in the second embodiment of the present invention;

FIG. 8 is a graph showing the results of measurement of the impedance of the shielded cable in the second embodiment of the present invention;

FIG. 9 is a cross-sectional view of a conventional embodiment shielded cable; and

FIG. 10 comprising sections (a) and (b) is a diagram schematically showing the state of connection between the conventional shielded cable and a connector.

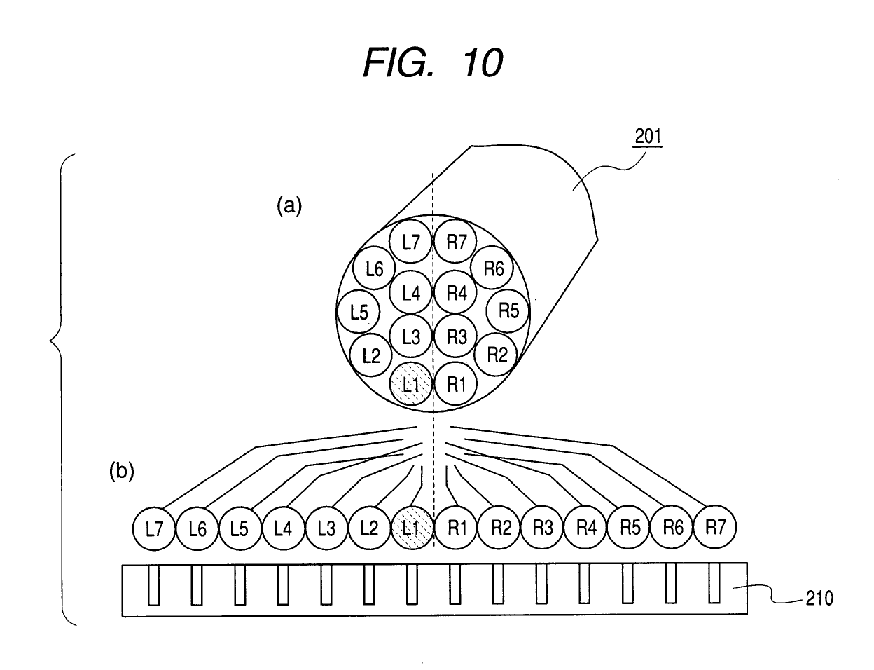

### DETAILED DESCRIPTION OF THE PREFERRED EMBODIMENTS

Preferred embodiments of the present invention will be described in detail with reference to the accompanying drawings.

(First Embodiment)

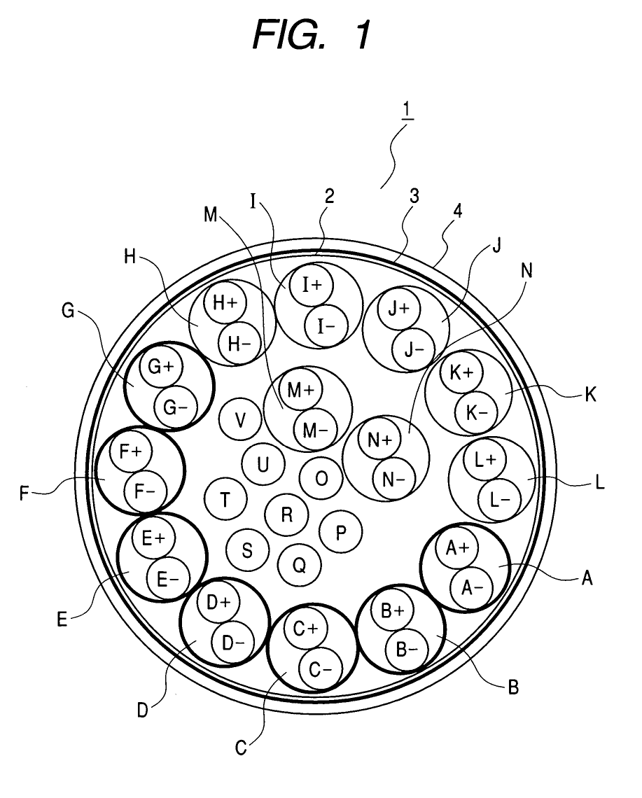

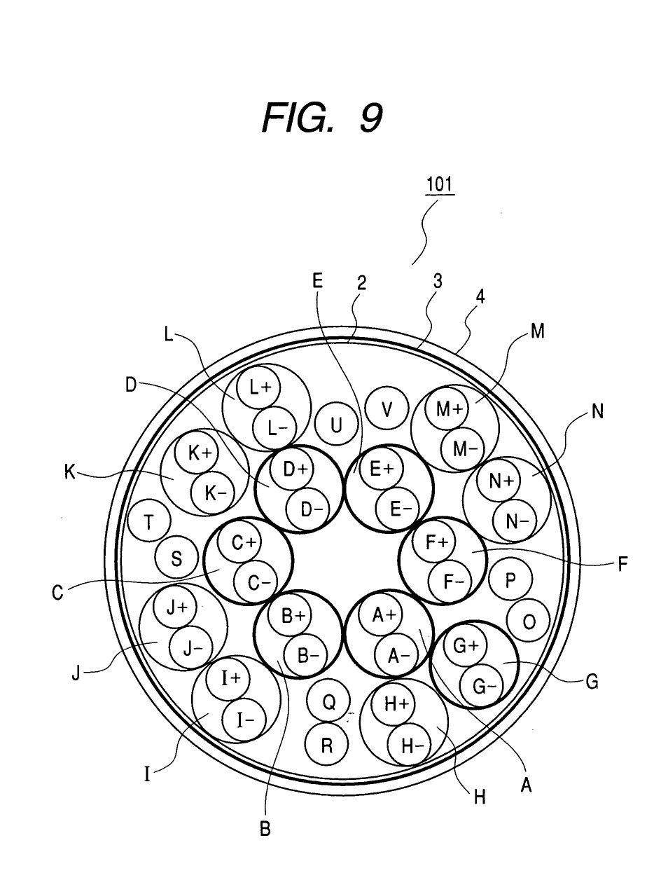

FIG. 1 is a cross-sectional view of a shielded cable in a first embodiment of the present invention, showing the placement of single wires and twisted pairs provided in the shielded cable. Thirty-six single wires are placed in the shielded cable. Seven twisted pairs each formed by twisting together two single wires and used to transceive high-rate signals, seven twisted pairs each formed by twisting together two single wires and used to transceive low-rate signals, seven ground lines each formed of a single wire and connected to ground, and one power supply line formed of a single wire and connected to a power supply are placed in the shielded cable. In FIG. 1, the components corresponding to those in the conventional art described above with reference to FIG. 9 are indicated by the same reference symbols.

Referring to FIG. 1, the shielded cable indicated by reference numeral 1 has single wires A+, A−, B+, B−, C+, C−, D+, D−, E+, E−, F+, F−, G+, G−, H+, H−, I+, I−, J+, J−, K+, K−, L+, L−, M+, M−, N+, N−, O, P, Q, R, S, T, U, and V each covered with an insulating sheathe. Each of pairs of single wires A+ and A−, B+ and B−, C+ and C−, D+ and D−, E+ and E−, F+ and F−, G+ and G−, H+ and H−, I+ and I−, J+ and J−, K+ and K−, L+ and L−, M+ and M−, and N+ and N− are twisted together to form fourteen twisted pairs A, B, C, D, E, F, G, H, I, J, K, L, M, and N. Seven pairs A, B, C, D, E, F, and G in the fourteen twisted pairs are for transceiving signals at a high rate of 10 MHz or higher. Seven pairs H, I, J, K, L, M, and N are for transceiving signals at a low rate of 10 MHz or lower. The single wire O is a power supply line connected to an external power source via connectors etc., and the seven single wires P, Q, R, S, T, U and V are ground lines connected to an external ground via connectors etc. All the thirty-six signal wires are covered with an insulating film 2. An outer shield 3 in the form of a braid or the like is formed outside the insulating film 2. The outer surface of the outer shield 3 is covered with covered with a jacket 4 made of an insulating material. The shielded cable 1 is formed by twisting the signal wires bundled together and by covering the surface of the bundled signal wires with the insulating film 2, the outer shield 3 and the jacket 4.

Referring to FIG. 1, all of the twisted pairs A, B, C, D, E, F, and G for transceiving high-rate signals are placed in an outer layer adjacent to the outer shield 3. Therefore, each of the twisted pairs A, B, C, D, E, F, and G is capacitively coupled to the outer shield 3 much more strongly than the conductors of the other single wires and twisted pairs existing in the vicinity of the twisted pairs A, B, C, D, E, F, and G. Therefore, the distance of each of the twisted pairs A, B, C, D, E, F, and G to the outer shield 3 is a dominant parameter in determination of the impedance of the twisted pairs. Since the outer shield 3 is connected to external ground via a connector or the like, the potential of the outer shield 3 is constant and the impedance of each of the twisted pairs A, B, C, D, E, F, and G can be stabilized.

The twisted pairs A, B, C, D, E, F, and G is in the same condition with respect to the outer shield 3. Therefore there is no difference between the impedance values of the twisted pairs. Each of the twisted pairs A, B, C, D, E, F, and G to be placed in the outer layer is not positioned in the inner layer but unfailingly positioned in the outer layer when the cable is manufactured by twisting together the single wires and twisted pairs. Therefore, the distance between each of the twisted pairs A, B, C, D, E, F, and G and the outer shield 3 is constant with respect to the position in the lengthwise direction of the shielded cable 1 and there is substantially no difference between the impedance values of the twisted pairs. The impedance value of the twisted pairs A, B, C, D, E, F, and G can be easily adjusted finely by changing the thickness of the insulating film 2. Thus, the facility with which the shielded cable is designed is improved.

Since all the twisted pairs A, B, C, D, E, F, and G are placed in the outermost layer in the shielded cable 1, the twisting pitches of the twisted pairs can be equalized. As a result, the wiring lengths of the twisted pairs can be equalized to reduce the occurrence of a skew in the shielded cable.

Since all the twisted pairs A, B, C, D, E, F, and G shown in FIG. 1 as wires for transceiving high-rate signals are placed so as to be adjacent one to another, all connector pins of a connector to which the twisted pairs A, B, C, D, E, F, and G of the shielded cable 1 are connected can be collectively wired at adjacent positions at the connection between the end of the shielded cable and the connector.

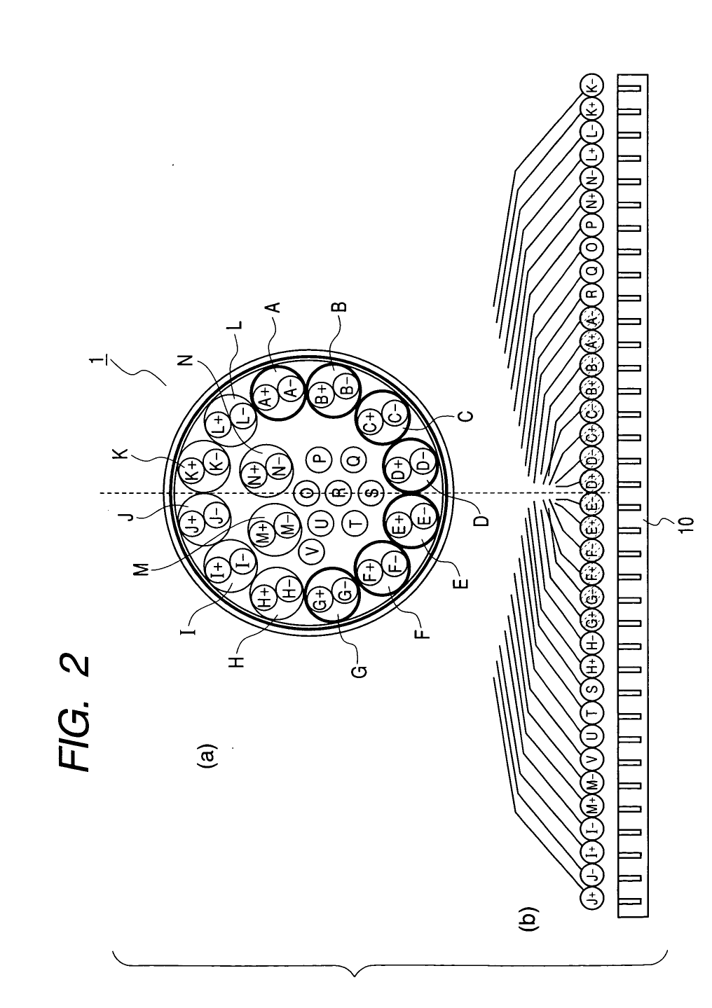

The state of wire connection between the shielded cable 1 and a connector 10 is illustrated in (a) and (b) of FIG. 2. Section (a) of FIG. 2 is a cross-sectional view of the same shielded cable 1 as that of the first embodiment shown in FIG. 1, and section (b) of FIG. 2 is a diagram schematically showing a state in which the signal wires are separated from each other and connected to a connector 10.

When the cable is connected to the connector, the bundled single wires and twisted pairs are separated from each other at their ends and the separated single wires are connected one by one to contact pins of the connector 10. When the single wires of the shielded cable 1 are connected, they are parted at a position indicated by a dotted line into halves to be led to left and right portions of the connector 10. The parted single wires are connected in order from one of the contact pins closer to a center of the connector 10. On the left-hand side of the center, the single wires are connected in the order of E−, E+, F−, F+, G−, and G+. On the right-hand side, the single wires are connected in the order of D+, D−, C+, C−, B+, B−, A+, and A−. Thus, the contact pins to which the twisted pairs A, B, C, D, E, F, and G are connected are in adjacent positions, the wiring lengths of the twisted pairs are generally equal to each other, and the occurrence of a skew can be reduced.

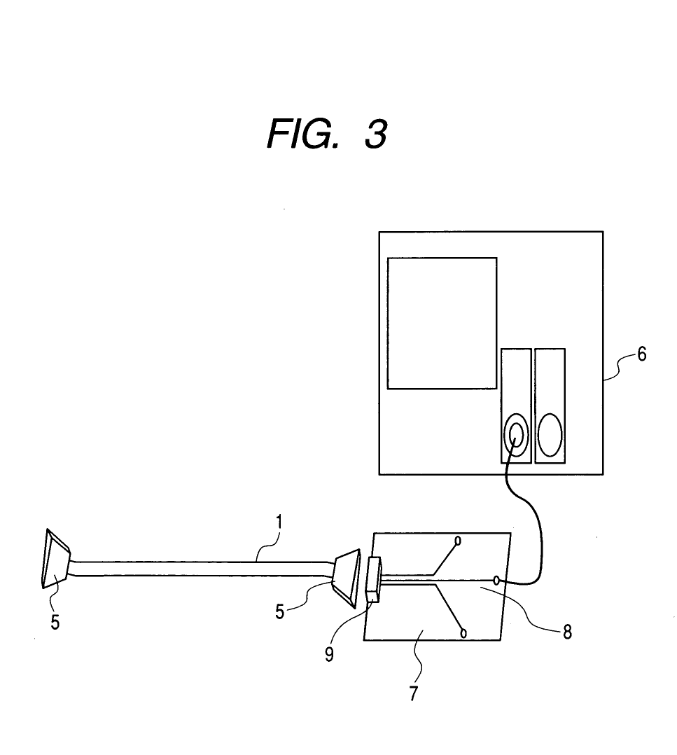

Measurement of the impedance value of the shielded cable 1 in the form shown in FIG. 1 was performed by using a measuring apparatus shown in FIG. 3. In FIG. 3, connectors to which the two ends of the shielded cable are connected are indicated by reference numeral 5, a time region reflection type of oscilloscope is indicated by reference numeral 6, and a jig printed circuit board is indicated by reference numeral 7. Wiring 8 and a connector 9 are mounted on the surface of the jig printed circuit board 7. The single wires in the interior of the shielded cable 1 are connected to the contact pins of the connectors 5. Contact pins corresponding to those in the connector 5 are provided in the connector 9 and are connected to the signal wiring 8. The same number of wiring as that in the wiring in the interior of the shielded cable 1 is formed in the wiring 8.

The length of the shielded cable 1 used is 1 m. The diameter of the cable 1 including the jacket 4 is about 7 mm. The diameter of each single internal wire is about 0.3 mm. However, the diameter of each single wire in this embodiment is not limited to this value.

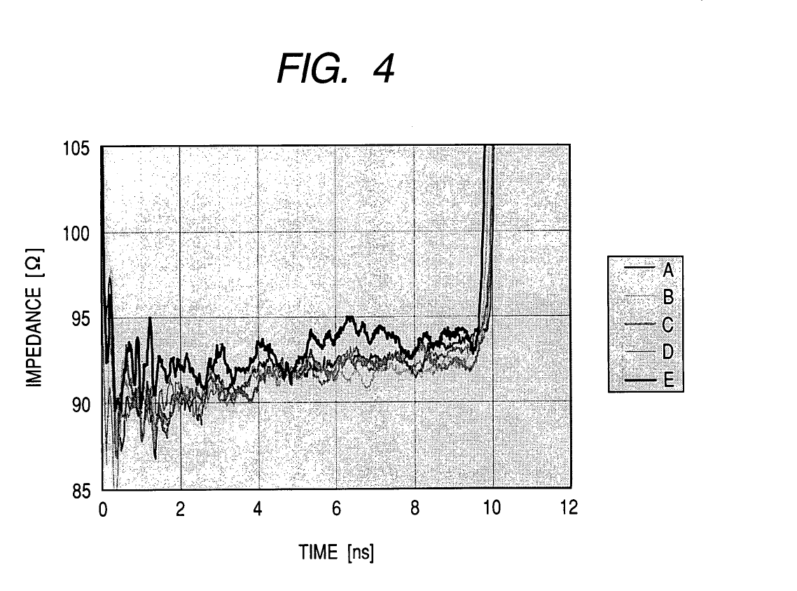

First, the connector 5 at one end of the shielded cable 1 was attached to the connector 9 on the jig printed circuit board 7. At this time, the connector 5 at the other end of the shielded cable 1 was left in an open state. Next, the oscilloscope 6 was connected to the conductor connected to the twisted pair A in the wiring 8 on the jig printed circuit board 7 to be measured. A step pulse signal (rise time 70 ps, amplitude 200 mV) was input from the oscilloscope 6 to the twisted pair A in the shielded cable 1 through the wiring 8, the connector 9 and the connector 5. The reflected waveform when the signal was input was measured with the oscilloscope 6, and the impedance of the twisted pair A at each of different positions in the shielded cable 1 was calculated from the measured value. The impedance of each of the twisted pairs B, C, D, and E was also measured in the same manner. FIG. 4 shows the results of this measurement. The abscissa of FIG. 4 represents the signal propagation time and the ordinate presents the impedance of each twisted pair. Graphs A to E in FIG. 4 present the results of measurements of the twisted pairs A to E in the shielded cable 1 shown in FIG. 1. The shielded cable 1 was designed in advance so that the impedance of each of the twisted pairs A to E was 100 Ω.

The signal propagation time on the abscissa is the time period during which the signal reflected at each position in the shielded cable 1 propagates to return. The propagation time can be read in terms of the length of the shielded cable 1. That is, the portion from 1 to 9.5 nsec in FIG. 4 comprises the measurement results corresponding to the lengths of different sections in the shielded cable 1. That is, the impedance value at the 1 nsec represents the impedance at the connection to the connector at the starting end of the shielded cable 1, while the impedance value at 9.5 nsec represents the impedance at the connection to the connector at the terminal end of the shielded cable 1. Each of intermediate values corresponds to the impedance at the corresponding position between the starting and terminal ends of the shielded cable 1.

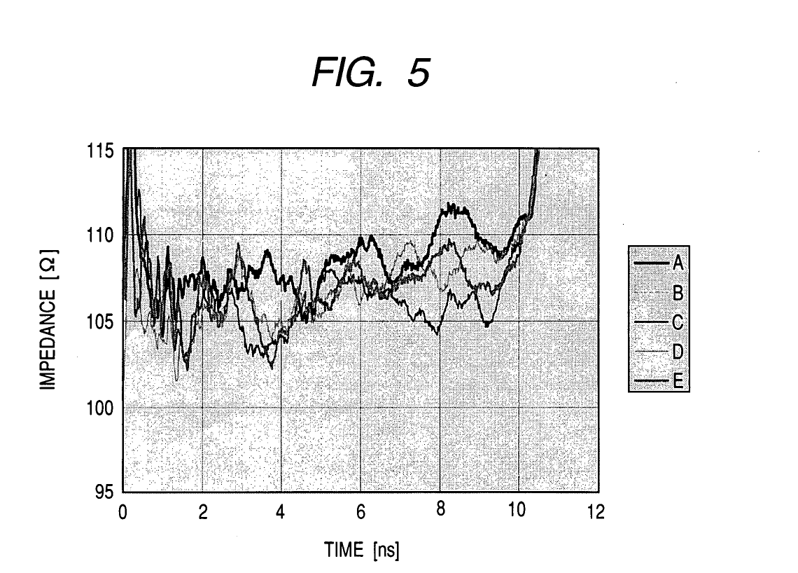

For comparison, the 1 m long shielded cable 101 according to the conventional art shown in FIG. 9 was also measured with the same measuring apparatus and by the same measuring method. FIG. 5 shows the results of this measurement, i.e., the impedance of each of twisted pairs A to E for transceiving high-rate signals inside the shielded cable 101. The shielded cable 101 was designed in advance so that the impedance of each of the twisted pairs A to E was 100 Ω.

As can be read from FIG. 4, the impedance of each of the twisted pairs A to E in the shielded cable 1 shown in FIG. 1 is within the range from 92 to 100 Ω and the difference from the design value 100 Ω is not larger than 8 Ω throughout the entire region of the shielded cable 1. The variation in impedance of each twisted pair at each position in the shielded cable is not larger than 5 Ω. It can be said that the impedance of each twisted pair is generally constant. Also, relative variation in impedance between the twisted pairs A to E is 5 Ω or less and the pair-to-pair variation is advantageously very small.

In contrast, the impedance of the twisted pairs A to E in the shielded cable 101 shown in FIG. 5 varies 108 to 118 Ω and the difference from the design value 100 Ω is large, 18 Ω at the maximum. It is also recognized that the variation in impedance of each twisted pair at each position in the shielded cable is 5 Ω or larger. Also, relative variation in impedance between the twisted pairs A to E is considerably large, i.e., 5 Ω or larger at several points.

Thus, the impedance of each of the twisted pairs A to E in the shielded cable 1 shown in FIG. 1 as an embodiment of the present invention is effectively stabilized in comparison with the shielded cable 101 in the case of the conventional art shown in FIG. 9, and the present invention has the effect of suppressing radiant noise.

(Second Embodiment)

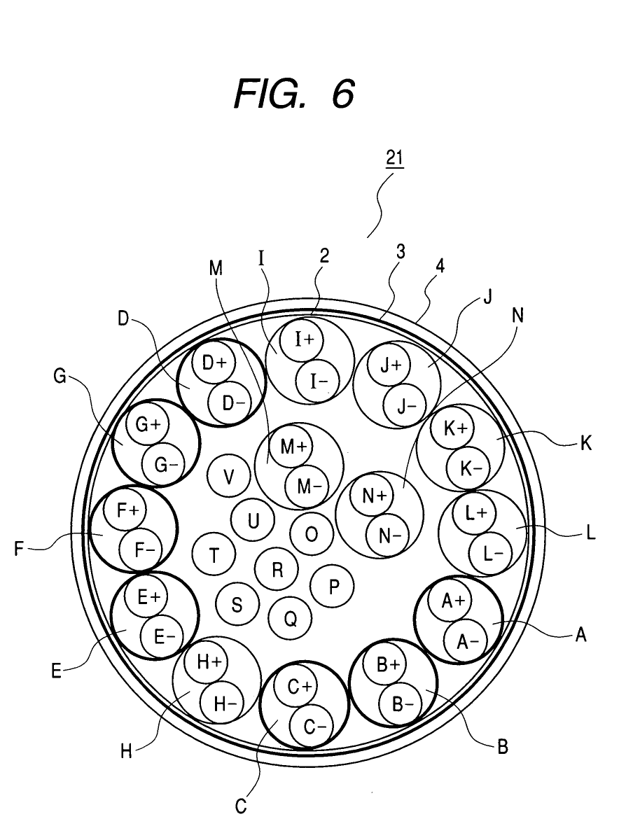

FIG. 6 is a cross-sectional view of a shielded cable 21 in a second embodiment of the present invention, showing the placement of single wires and twisted pairs provided in the shielded cable 21. Thirty-six single wires are placed in the interior of the shielded cable. Seven twisted pairs each formed by twisting together two single wires and used to transceive high-rate signals, seven twisted pairs each formed by twisting together two single wires and used to transceive low-rate signals, seven ground lines each formed of a single wire and connected to ground, and one power supply line formed of a single wire and connected to a power supply are placed in the shielded cable. In FIG. 6, the components corresponding to those shown in FIG. 1 are indicated by the same reference symbols.

Referring to FIG. 6, all of the twisted pairs A, B, C, D, E, F, and G for transceiving high-rate signals are placed in an outer layer adjacent to an outer shield 3. Also, as shown in FIG. 6, the twisted pairs A, B, and C are placed so as to be adjacent one to another. The twisted pairs D, E, F, and G are also placed so as to be adjacent one to another. A twisted pair H for transceiving a low-rate signal is placed between the groups of twisted pairs A, B, and C and the groups of twisted pairs D, E, F, and G.

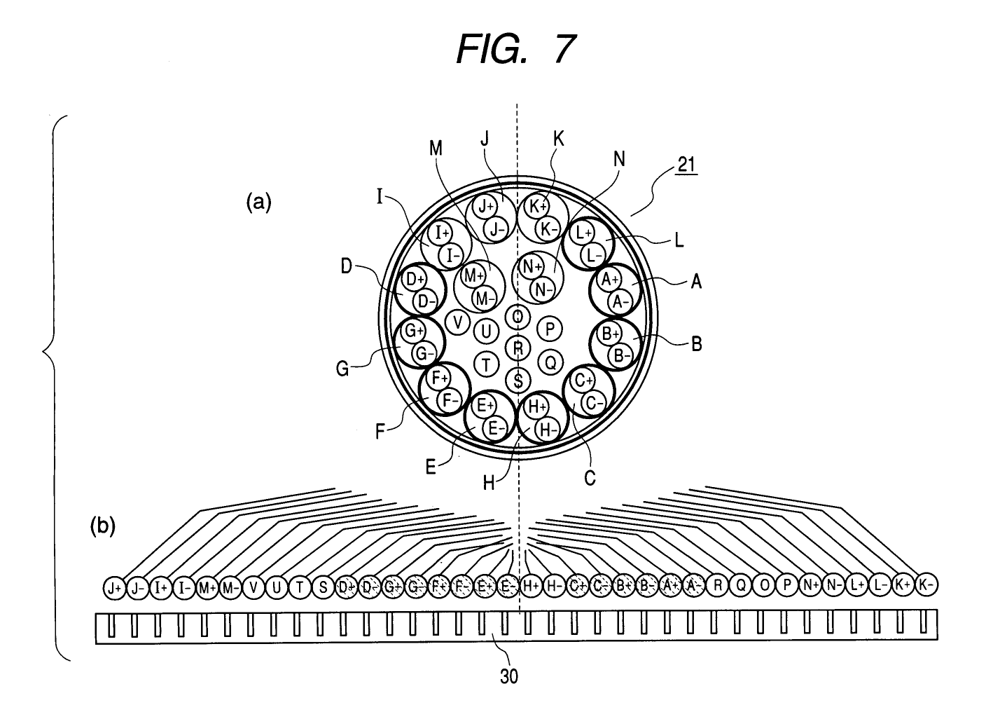

The state of wire connection between the shielded cable 21 and a connector 30 is illustrated in (a) and (b) of FIG. 7. Section (a) of FIG. 7 is a cross-sectional view of the same shielded cable 21 as that shown in FIG. 6, and section (b) of FIG. 7 is a diagram schematically showing a state in which the single wires are separated from each other and connected to connector pins of the connector 30.

When the cable is connected to the connector, the bundled single wires and twisted pairs are separated from each other at their ends and the separated single wires are connected one by one to the connector. When the single wires of the shielded cable 21 are connected, they are parted at a position indicated by a dotted line into halves to be led to left and right portions of the connector 30. The parted single wires are connected in order from one of the contact pins closer to a center of the connector 30. On the left-hand side of the center, the single wires are connected in the order of E−, E+, F−, F+, G−, G+, D−, and D+. On the right-hand side, the single wires are connected in the order of H+, H−, C+, C−, B+, B−, A+, and A−.

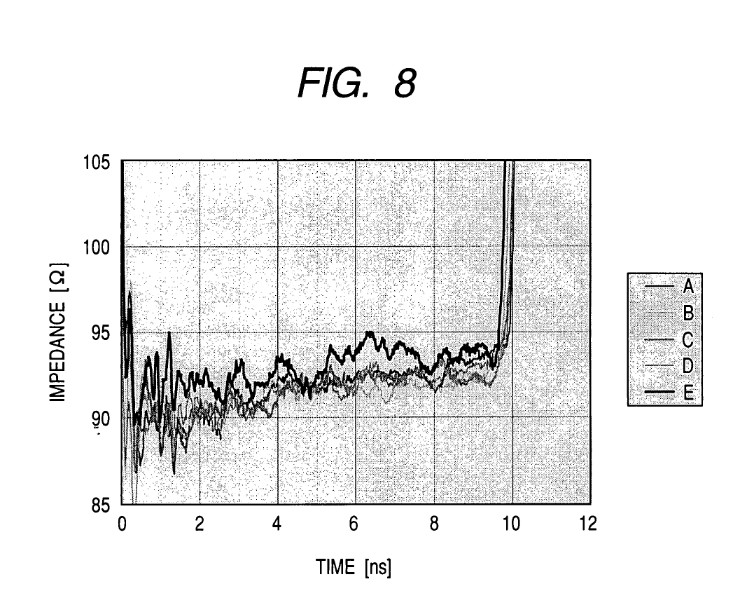

The shielded cable 21 shown in FIG. 6 was measured with the same measuring apparatus and by the same measuring method as those in the first embodiment. FIG. 8 shows the results of this measurement, i.e., the impedance of each of twisted pairs A to E for transceiving high-rate signals in the shielded cable 21. The shielded cable 21 was designed in advance so that the impedance of each of the twisted pairs A to E was 100 Ω.

As can be understood from the measurement results shown in FIG. 8, the impedance of the shielded cable of this embodiment is substantially the same as that of the shielded cable 1 shown in FIG. 1, and is generally close to the design value 100 Ω throughout the entire region of the shielded cable 21. The variation in impedance of each twisted pair at each position in the shielded cable 21 is not larger than 5 Ω. It can be said that the impedance of each twisted pair is generally constant. Also, relative variation in impedance between the twisted pairs A to E is 5 Ω or less and the pair-to-pair variation is advantageously very small.

The construction of the shielded cable in accordance with the present invention is particularly advantageous when the frequency of high-rate signals propagating through the twisted pairs is 10 MHz or higher. That is, presently, radiant noise relating to electronic appliances must be limited in the range from thirty megahertz to several gigahertz. Ordinarily, digital signals have harmonic components of frequencies about 3 to 20 times higher. Therefore, it is desirable that signals having frequencies higher than 10 MHz be treated as a high-rate signal, and that a shielded cable assembly in which a signal arrangement such as that described above in the description of the embodiments is made be used to transmit such a signal. The signal waveform is shaped by stabilizing the impedance of the shielded cable to reduce harmonic components. In this manner, radiant noise at high frequencies can be reduced.

A clock signal of 10 MHz has a fundamental frequency of 10 MHz and harmonic components of 30 MHz (triple wave), 50 MHz (quintuple wave), . . . 210 MHz (21-fold wave). The level of radiant noise in the frequency band of from 30 to 210 MHz of the harmonic components is generally proportional to the amount of current in the frequency band of from 30 to 210 MHz. Therefore, it is possible to reduce the harmonic component current of from 30 to 210 MHz by stabilizing the impedance of the shielded cable and to thereby suppress radiant noise in the frequency band of from 30 to 210 MHz.

According to the present invention, as described above, in a shielded cable which has a plurality of signal wires for transmitting digital signals of a relatively high frequency and a plurality of signal wires for transmitting digital signals of a relatively low frequency, and in which the signal wires are bundled in a state of being electrically insulated from each other and all the signal wires are collectively covered with a conductor, the plurality of signal wires for transmitting digital signals of a relatively high frequency are placed in the outermost layer of the shielded cable adjacent to the conductor so as to be adjacent one to another, thus making it possible to easily and stably perform impedance control and skew control of the signal wires for transceiving high-rate parallel signals without using cost-increasing means such as addition of ground and power supply wires. In particular, the impedance characteristic of the twisted pairs for transceiving high-rate parallel signals can be set in accordance with the design value to limit variation in impedance of the shielded cable in the lengthwise direction and relative variation between the twisted pairs for transceiving high-rate parallel signals. As a result, maintenance of improved signal quality and more reliable suppression of radiant noise can be achieved even if the rate at which signals are transmitted through the shielded cable is further increased.

The present invention is capable of suppressing radiant noise more effectively with respect a high-rate signal which is a clock signal of 10 MHz or higher or a data signal synchronized with clock signal of 10 MHz or higher.

What is claimed is:

1. A shielded cable comprising:
first signal wires for transmitting digital signals of a relatively high frequency;
second signal wires for transmitting digital signals of a relatively low frequency; and
a conductor with which said first and second signal wires bundled in a state of being electrically insulated from each other are collectively covered,
wherein said first signal wires are placed adjacent to said conductor and adjacent one to another.

2. The shielded cable according to claim 1, wherein said first signal wires are twisted pairs.

3. The shielded cable according to claim 1, wherein a clock signal of 10 MHz or higher and a plurality of data signals synchronized with the clock signals are transmitted through said first signal wires.

4. The shielded cable according to claim 1, further comprising connectors for connection at its opposite ends, each of said connectors having connector pins being connected to said first and second signal wires, said first signal wires being connected to particular ones of the connector pins which are adjacent one to another.
